(19) United States
(12) Patent Application Publication
(10) Pub. No.: US 2007/0053543 A1
(43) Pub. Date: Mar. 8, 2007

(54) Bluetooth wireless headset having earphone

(75) Inventor: Young-Soon Lee, Busan (KR)

Correspondence Address: GWIPS;PETER T. KWON, P.O. BOX 231630, CENTERVILLE, VA, 20120, US

(73) Assignee: SIMPLEBE CO., LTD.

(21) Appl. No.: 11/515,744

(22) Filed: Sep. 5, 2006

(30) Foreign Application Priority Data
Sep. 6, 2005 (KR) 10-2005-0082933
Oct. 19, 2005 (KR) 20-2005-0029929
May 25, 2006 (KR) 10-2006-0046922
Jul. 21, 2006 (KR) 10-2006-0068640

(51) Int. Cl. H04R 25/00

(52) U.S. Cl. 381/381; 381/374

(57) ABSTRACT

A Bluetooth wireless headset is invented comprising an earphone having a speaker, a telescopic part, to which the earphone is attached, and a body including a built-in Bluetooth chip. The body is bar-shaped and has a space for receiving the telescopic part. The telescopic part is movable through the space between the earphone and the body. The earphone moves inward to a stowed position in response to a single push and moves outward to an extended position in response to a second push, so as to be conveniently used and stored.

### BACKGROUND OF THE INVENTION

1. Field of the Invention

The present invention relates to a Bluetooth wireless headset having equipped an earphone. Particularly, it has adopted a push button module so that the earphone moves inward in response to a single push and moves outward in response to a second push.

2. Description of the Prior Art

Recently, separate wireless headsets have been used as accessories for an electronic devices functioning as a main body such as a mobile phone or an MP3 player. By using such a wireless headset, a user can use an electronic device such as a mobile phone or an MP3 player without having to hold it in his/her hand. The usage of such a wireless headset has been enabled by the development of local wireless communication technologies such as Bluetooth.

The wireless headset is typically provided with a frame, which is shaped in a similar manner to an earflap, and can be formed integrally with or separately from the wireless headset. The frame of the wireless headset is hung on the earflap so that the wireless headset can remain stationary in a mounting position. However, this frame is inconvenient to use since a user can attach the headset to him/her only through a complicated operation. For example, the user must hook the frame around his/her ear or deform the frame, and it is not easy at all to attach the wireless headset in the correct position.

Furthermore, the frame increases the overall size of the wireless headset, and due to its hook-like configuration, is frequently caught by other objects, such as a pocket flap. To overcome such problems, a headset as shown in FIG. 1 was developed.

Referring to FIG. 1, the exterior of the headset is composed of an earphone for outputting audio signals and a body to which the earphone is attached. Although not shown in the drawing, the body is fitted with a receiver for receiving radio signals and a circuit (Bluetooth chip) for amplifying and modulating the radio signals to send audio signals to the earphone where a speaker is mounted.

As seen in FIG. 1, in this headset, the earphone projects from the body so that the earphone can be easily inserted into an ear hole and the headset can be easily attached to the ear. Then, the earphone is smoothly seated into the ear hole.

However, when the headset is not used, the user carries the headset typically in his/her bag or pocket (e.g., of a shirt or trousers). When the headset is kept in a pocket, the projecting earphone or an ear hook may press against a body part (e.g., chest or thigh), which is unpleasant to the user. If the headset is put in a bag, the exposed earphone or the ear hook may damaged by contacting with other articles.

### SUMMARY OF THE INVENTION

Accordingly, the present invention has been made to solve the above-mentioned problems occurring in the prior art, and an object of the present invention is to provide a Bluetooth wireless headset having an earphone, in which the earphone is retracted into a body when the headset is not in use, but extended from the body when the headset is used so that the headset can be attached to an ear, by which a user can use the headset conveniently.

A further object of the invention is to provide a Bluetooth wireless headset having an earphone, in which the earphone is mounted inside a body but can be folded to be inserted into an ear hole when the headset is in use.

A further object of the invention is to provide a Bluetooth wireless headset having an earphone, in which the earphone is hinged about a rotation axis, such that it is able to rotate, but will not protrude from a body when the headset is not in use, by which an ear hook is no longer necessary and user convenience is improved.

According to an aspect of the invention for realizing any of the above objects, there is provided a Bluetooth wireless headset including: an earphone having a speaker; a telescopic part to which the earphone is attached; and a body including a built-in Bluetooth chip, wherein the body is bar-shaped and has a space for receiving the telescopic part, wherein the telescopic part is movable outward to and inward from the earphone.

According to another aspect of the invention for realizing any of the above objects, there is provided a Bluetooth wireless headset including: an earphone having a speaker; a telescopic part to which the earphone is attached; and a body including a built-in Bluetooth chip, wherein the body is bar-shaped and has a space defined by a partition for allowing the telescopic part to move forward to and inward from the earphone; an earphone-receiving recess depressed into the space from an upper part thereof; and a push switch module having a locking member, arranged at a side of the space to fix the telescopic part of the earphone.

According to yet another aspect of the invention for realizing any of the above objects, there is provided a Bluetooth wireless headset including: an earphone having a speaker; a telescopic part to which the earphone is attached; and a body including a built-in Bluetooth chip, wherein the body is bar-shaped and has a space defined by a cylindrical partition for allowing the telescopic part to move outward to and inward from the earphone; an earphone-receiving recess depressed into the space from an upper part thereof, and a locking part arranged in the partition of the body for fixing the telescopic part of the earphone.

According to yet another aspect of the invention for realizing any of the above objects, there is provided a Bluetooth wireless headset including: a movable earphone having a speaker; and a body including a built-in Bluetooth chip, the body having a space for receiving the earphone, wherein the earphone is hinge-mounted on the body.

According to yet another aspect of the invention for realizing any of the above objects, there is provided a Bluetooth wireless headset including: a movable earphone having a speaker; and a body including a built-in Bluetooth chip, wherein the earphone is mounted on the exterior of the body, the earphone being rotatable about a rotation shaft.

### BRIEF DESCRIPTION OF THE DRAWINGS

FIG. 1 is a perspective view illustrating a conventional wireless headset.

FIG. 2 is a perspective view illustrating a Bluetooth headset having an earphone of the invention.

FIG. 3 is a perspective view illustrating a telescopic part of the Bluetooth headset having an earphone according to a first embodiment of the invention.

FIG. 4 is a cross-sectional view taken along the line A-A of FIG. 2.

FIG. 5 is a cross-sectional view taken along the line B-B of FIG. 2.

FIG. 6 is a cross-sectional view illustrating the operation of the Bluetooth headset having an earphone according to the first embodiment of the invention.

FIG. 7 is a perspective view illustrating a telescopic part of the Bluetooth headset having an earphone according to a second embodiment of the invention.

FIG. 8 is a front cross-sectional view illustrating the Bluetooth headset having an earphone according to the second embodiment of the invention.

FIG. 9 is a side cross-sectional view illustrating the Bluetooth headset having an earphone according to the second embodiment of the invention.

FIGS. 10a to 10c are cross-sectional views illustrating the operation of the Bluetooth headset having an earphone according to the second embodiment of the invention.

FIGS. 11a to 11c are cross-sectional views illustrating the operation of the Bluetooth headset having an earphone according to a third embodiment of the invention.

FIG. 12 is an explanatory view illustrating the operation of the Bluetooth headset having an earphone according to the fourth embodiment of the invention.

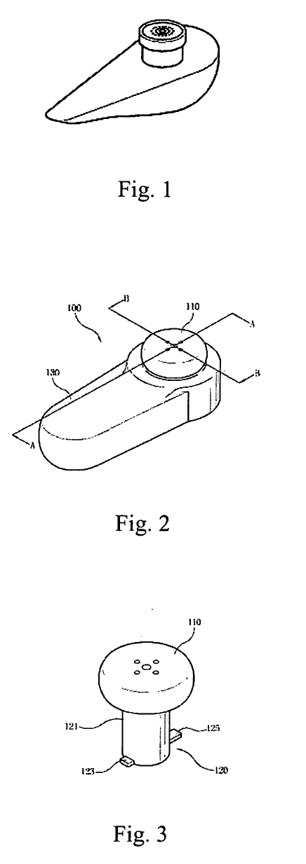

### DETAILED DESCRIPTION OF THE PREFERRED EMBODIMENTS

The following detailed description will present preferred embodiments of a Bluetooth wireless headset having an earphone according to the invention with reference to the accompanying drawings, in which well-known functions or constructions will not be described in detail since they would unnecessarily obscure the intent of the invention. The following terminologies are used based on their functions in the present invention but may be construed differently according to the intention or practices of users and operators. Accordingly, the terminologies shall be defined based on the general context of the specification.

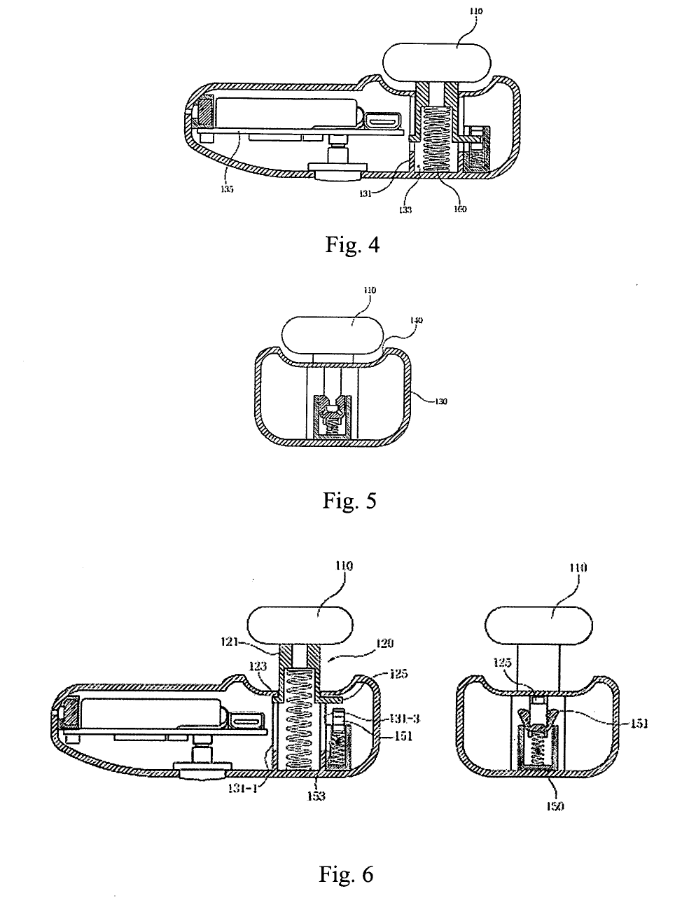

FIG. 2 is a perspective view illustrating a Bluetooth headset 100 of the invention, FIG. 3 is a perspective view illustrating a telescopic part 120 of the Bluetooth headset 100 according to a first embodiment of the invention, FIG. 4 is a cross-sectional view taken along the line A-A of FIG. 2, and FIG. 5 is a cross-sectional view taken along the line B-B of FIG. 2.

Referring to FIGS. 2 to 5, the Bluetooth headset 100 of the invention includes an earphone 110, a telescopic part 120, a body 130, an earphone recess 140, a push switch module 150 and a coil spring 160.

First, the earphone 110 has a speaker unit mounted therein, which reproduces an electric signal as an audio signal by vibrating the air. An insert member made of a soft material is provided at one end of the earphone 110 which deforms when inserted into an ear of a user. Once the insert member is inserted into the ear, the inserted position can be maintained stably. Accordingly, the Bluetooth headset 100 with the earphone 110 does not need any frame that is shaped similar to an earflap or other part for hanging the headset 100 on the ear.

The telescopic part 120 includes a hollow cylinder 121, a guide protrusion 123 and a coupling protrusion 125. The guide protrusion 123 projects horizontally from the bottom end of the cylinder 121, and serves to guide extension/retraction while preventing separation of the telescopic part 120. The coupling protrusion 125 projects horizontally opposite from the guide protrusion 123. The coupling protrusion 125, in case of retraction, is coupled with a locking member 151 of the push switch module 150, to be explained hereafter, and fixed with the push switch module 150. In case of extraction, the coupling protrusion 125 is uncoupled from the locking member 151 of the push switch module 150. Here, the height or length of the telescopic part 120 is preferably set to such an extent that the coupling protrusion 125 can be locked into and unlocked from the locking member 151.

The body 130 is bar shaped, and has a circular partition 131 defining a space 133 where the telescopic part 120 can perform reciprocating movement (i.e., upward/downward movement in the drawings).

Here, the partition 131 has a first guide slit 131-1 and a second guide slit 131-3. The first guide slit 131-1 is arranged in a corresponding position to guide the reciprocating movement of the guide protrusion 123 of the telescopic part 120. The second guide slit 131-3 is arranged in a corresponding position to guide the reciprocating movement of the coupling protrusion 125 of the telescopic part 120 so that the coupling protrusion 125 projects out through the partition 131.

On the exterior of the body 130, some components are provided, which include a volume controller by which a user can control the volume, a microphone for receiving the voice of the user, an on/off button for turning on/off the power of the wireless headset 100 and a charge terminal for charging the battery.

In the interior of the body 130, other components are further provided, which include a Bluetooth module for performing wireless communication with a main body such as an MP3 player or a mobile phone, an amplifier circuit for amplifying signals transmitted/received by the Bluetooth module and a circuit for reproducing amplified sound waves into certain electric signals. These components of course cooperate to operate the wireless headset, and are preferably mounted on a board 135 arranged inside the body 130.

The earphone recess 140 is depressed into the body 130 from the top surface thereof, in the form of a hemisphere, so that the earphone 110 does not project out of the body 130 when retracted into the body 130.

The push switch module 150 is a locking type module, in which the locking member 151 is V-shaped to spread out during the reciprocating movement through the inside of the body 130. (Here, the locking member 151 is locked in response to a first actuation, but unlocked in response to a second actuation.) The push switch module 150 is arranged at a side of the space 133 of the body 130. Here, the push switch module 150 also includes a third guide slit 153 in a side of the push switch module 150. Through the third guide slit 153, the coupling protrusion 125 can move reciprocally. Here, the push switch module 150 has a known structure which remains in a pressed position when pushed down once but resets itself when pushed down again. Since this structure is well-known in the art, detailed description thereof will be omitted.

The coil spring 160 is fixed to the inside of the telescopic part 120 and to the bottom of the space 133, and serves to extend or retract the telescopic part 120 when the coupling protrusion 125 of the telescopic part 120 is decoupled from the locking member 151 of the push switch module 150.

With reference to FIG. 6, the operation of the Bluetooth wireless headset according to the invention will be described in detail as follows.

FIG. 6 is a cross-sectional view illustrating the operation of the Bluetooth headset according to the first embodiment of the invention.

When a user presses down (or in) on the earphone 110 while the telescopic part 120 is projecting from the earphone recess 140, the telescopic part 120 moves downward against the repulsive force of the coil spring 160.

The telescopic part 120 moves down vertically since it is received in the space 133 by the partition 131.

In response to the downward (or inward) movement of the telescopic part 120, the guide protrusion 123 of the telescopic part 120 moves down or descends along the first guide slit 131-1, and at the same time, the coupling protrusion 125 of the telescopic part 120 opposite to the guide protrusion 123 descends along the second guide slit 131-3 of the partition 131.

While descending along the second guide slit 131-3, the coupling protrusion 125 of the telescopic part 120 is inserted into the locking member 151 of the push switch module 150. As the coupling protrusion 125 of the telescopic part 120, now inserted into the locking member 151 of the push switch module 150, descends in succession along the third guide slit 153 of the push switch module 150, the locking member 151 is inserted into the push switch module 150 to fix the coupling protrusion 152 of the telescopic part 120.

When the locking member 151 of the push switch module 150 has descended to a specific point and the locking member 151 remains in the descended position, the coupling protrusion 125 of the telescopic part 120 remains stationary due to the locking member 151. Then, even if the user releases the pressure from the earphone 110, the earphone 110 fixed to the telescopic part 120 remains in the retracted position or the position stowed in the earphone recess 140. Here, after retraction, the push switch module 150 moves upward or ascends slightly and then remains locked.

On the contrary, when the user presses down the earphone 110 as an attempt to use the Bluetooth wireless headset 100, the push switch module 150 is unlocked and thus the locking member 151 is released to extend.

Then, the coupling protrusion 125 of the telescopic part 120 coupled with the locking member 151 extends together, and when the locking member 151 is extended completely and spread open, the coupling protrusion 125 is uncoupled from the locking member 151.

Then, as a fixing force is released from the telescopic part 120, the repulsive force of the coil spring 160 acting on the underside of the telescopic part 120 extends the telescopic part 120 so that the earphone 110 moves upward and projects from the earphone recess 140.

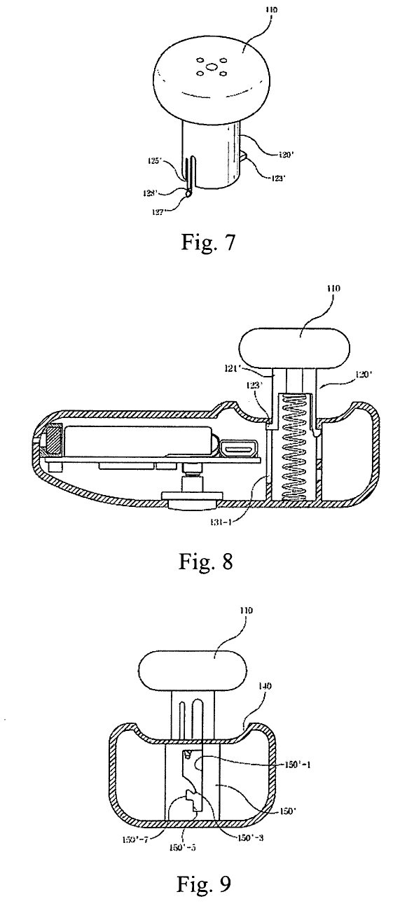

FIG. 7 is a perspective view illustrating a telescopic part 120′ of a Bluetooth headset 100 (see FIG. 2) according to a second embodiment of the invention, FIG. 8 is a front cross-sectional view of the Bluetooth headset 100 according to the second embodiment of the invention, and FIG. 9 is a side cross-sectional view of the Bluetooth headset 100 according to the second embodiment of the invention.

Referring to FIGS. 7 to 9, the headset 100 of this embodiment includes an earphone 110, the telescopic part 120′, a body 130, an earphone recess 140, a locking part 150′ and a coil spring 160.

First, the earphone 110 has a speaker unit mounted therein, which reproduces an electric signal into an audio signal through vibration of the air. An insert member made of a soft material is provided at one end of the earphone 110 which deforms when inserted into an ear of a user. Once the insert member is inserted into the ear, the inserted position can be maintained stably. Accordingly, the Bluetooth headset 100 with the earphone 110 does not need any frame that is shaped similar to an earflap, or other part for hanging the headset 100 on the ear.

The telescopic part 120′ includes a hollow cylinder 121′, a guide protrusion 123′ and a coupling pin 125′. The guide protrusion 123′ projects horizontally from the bottom end of the cylinder 121′, and serves to guide extension/retraction while preventing separation of the telescopic part 120′. The coupling pin 125′ is defined by longitudinal slots in a region corresponding to the guide protrusion 123′ of the cylinder 121′ so as to be coupled to and uncoupled from the locking part 150′ explained hereafter. An inclined coupling protrusion 127′ is provided at the end of the coupling pin 125′, and has a slope 128′ at the lower end thereof. Here, the height or length of the telescopic part 120′ is preferably set to such an extent that the coupling pin 125′ can be locked into and unlocked from the locking member 151.

The body 130 is bar shaped, and has a circular partition 131 defining a space 133 where the telescopic part 120′ can perform reciprocating movement (i.e., upward/downward movement in the drawings).

Here, the partition 131 has a guide slit 131-1 which is arranged in a corresponding position to guide the reciprocating movement of the guide protrusion 123′ of the telescopic part 120′.

On the exterior of the body 130, some components are provided such as a volume control by which a user can control the volume, a microphone for receiving the voice of the user, an on/off button for turning on/off the power of the wireless headset 100 and a charging terminal for charging the battery.

In the interior of the body 130, other components are further provided, which include a Bluetooth module for performing wireless communication with a main body such as an MP3 player or a mobile phone, an amplifier circuit for amplifying signals transmitted/received by the Bluetooth module and a circuit for reproducing amplified sound waves into certain electric signals. These components of course cooperate to operate the wireless headset, and are preferably mounted on a board 135 arranged inside the body 130.

The earphone recess 140 is depressed down into the body 130 from the top surface thereof, in the form of a hemisphere, so that the earphone 110 does not protrude out of the body 130 when in the retracted position.

The locking part 150′ includes a rectangular slit 150′-1 formed at a side of the partition 131, a coupling protrusion 150′-3, a guide protrusion 150′-5 and a guide surface 150′-7. The coupling protrusion 150′-3 extends inward from a longitudinal edge of the slit 150′-1 and has a downward slope so that the coupling protrusion 127′ of the coupling pin 125′ engages thereinto along the slope when it ascends from a descended position. The guide protrusion 150′-5 is formed at the lower end of the coupling protrusion 150′-3 in the shape of a quadrangle to bend the slope 128′ of the coupling protrusion 127′ of the coupling pin 125′ when guided thereinto. The guide surface 150′-7 is formed between the coupling protrusion 150′-3 and the guide protrusion 150′-3. With the guide surface 150′-7, when the coupling protrusion 127′ of the telescopic part 120′ ascends from the position bent by the guide protrusion 150′-5, it does not re-couple with the coupling protrusion 150′-3 of the locking part 150′. Here, the locking part 150′ has a known structure which remains in a pressed position when pushed down once but resets itself when pushed down again. Since this structure is well-known in the art, a detailed description thereof will be omitted.

The coil spring 160 is fixed to the inside of the telescopic part 120′ and to the bottom of the space 133, and serves to extend or retract the telescopic part 120′ when the coupling protrusion 127′ of the telescopic part 120′ is uncoupled from the locking part 150′.

With reference to FIG. 7, the operation of the Bluetooth wireless headset of this embodiment will be described in detail as follows.

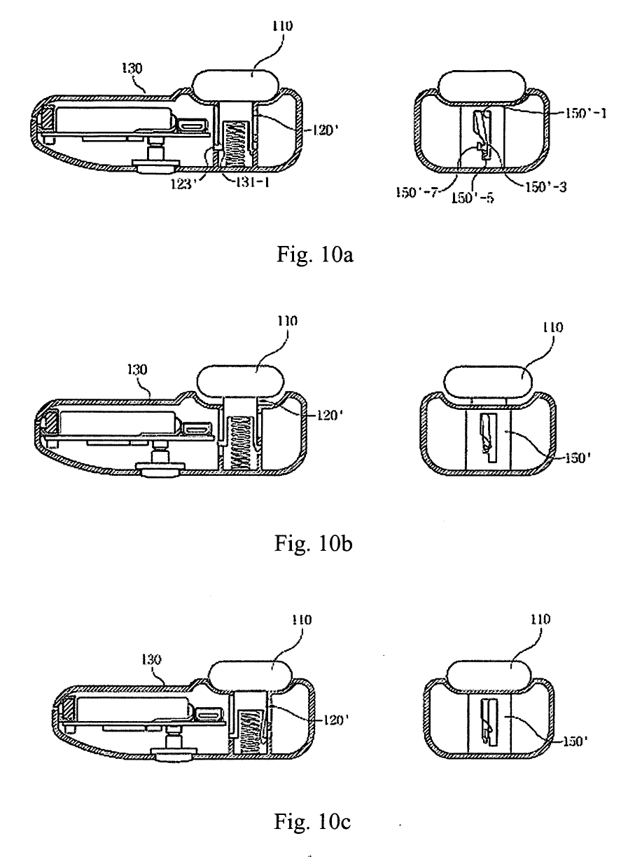

FIGS. 10a to 10c are cross-sectional views illustrating the operation of the Bluetooth headset according to the second embodiment of the invention.

When a user presses down (or in) on the earphone 110 from a position where the telescopic part 120′ is extended from the earphone recess 140, the telescopic part 120′ moves downward against the repulsive force of the coil spring 160.

The telescopic part 120 moves down vertically since it is received in the space 133 by the partition 131.

In response to the downward movement of the telescopic part 120′, the guide protrusion 123′ of the telescopic part 120′ descends along the guide slit 131-1 of the partition 131, and at the same time, the coupling protrusion 127′ of the telescopic part 120′ opposite to the guide protrusion 123 descends along the rectangular slit 150′-1 of the locking part 150′. In succession, when the coupling protrusion 127′ of the coupling pin 125′ of the telescopic part 120′ contacts the coupling protrusion 150′-3 of the locking part 150′, the coupling pin 125′ hinges as shown in FIG. 10b. Then, owing to the inclination of the coupling protrusion 127′, it moves along the slope of the coupling protrusion 150′-3. At the lower end of the coupling protrusion 150′-3 where there is no slope, the coupling protrusion 127′ converts from downward movement into horizontal movement (to the left on the drawing) under the restoring force of the coupling pin 125′, and owing to the inclination thereof, couples with the underside of the coupling protrusion 150′-3.

When the coupling protrusion 127′ of the coupling pin 125′ is fixed to the coupling protrusion 150′-3 of the locking part 150′, the earphone 110 fixed to the telescopic part 120′ remains in a descended position, that is, a position retracted into the earphone recess 140.

On the contrary, when the user presses down the earphone 110 as an attempt to use the Bluetooth wireless headset 100, the coupling protrusion 127′ of the coupling pin 125′ moves downward, and thereby the slope 128′ of the coupling protrusion 127′ is guided and bent by the guide protrusion 150′-5.

Then, the telescopic part 120′ is pushed upward from the bent position under the repulsive force of the coil spring 160. During the upward movement, the coupling protrusion 127′ of the coupling pin 125′ ascends vertically, but owing to its bent position maintained by the guide surface 150′-7, does not re-couple with the coupling protrusion 150′-3 of the locking part 150′.

Then, the telescopic part 120′ continues to ascend so that the earphone 110 moves upward and protrudes from the earphone recess 140.

Therefore, the headset of this embodiment can prevent problems of conventional earphones which are likely to be damaged owing to contact with a body part or an external object.

The technical idea of the first and second embodiments of the invention is to retract the telescopic part, on which the earphone is seated, into the space in the body via a single downward push and to extend the telescopic part from the body via a second downward push. It should be construed that any telescopic parts having these features, if the functions are identical, be embraced within the scope of the invention regardless of partial changes in the construction.

Furthermore, the first and second embodiments are illustrative only but applicable to all types of headsets having a telescopic part such as an ear ring-type headset, a telemarketer's headset and a computer headset.

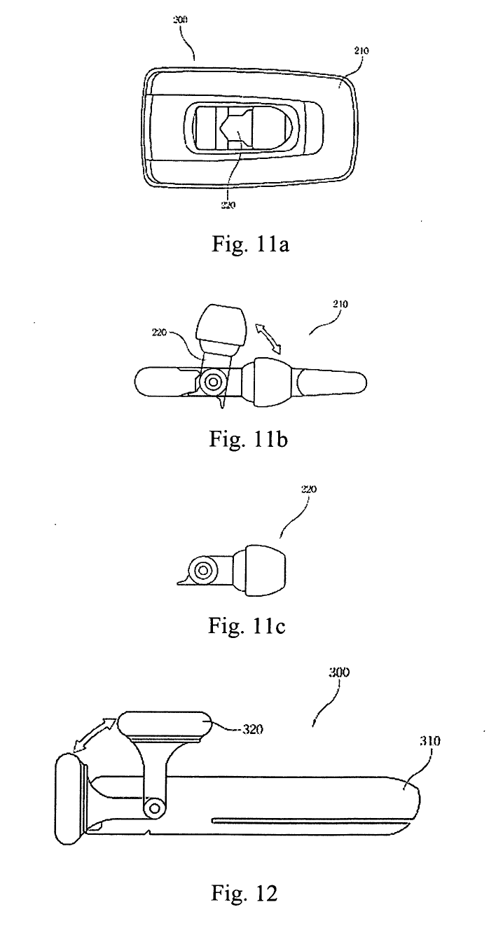

FIGS. 11a to 11c illustrate a third embodiment of the invention.

FIG. 11a is a plan view of a Bluetooth wireless headset 200 having an earphone 220 which is placed in a central portion of a body 210. In particular, the earphone 220 is placed in a recess defined in the central portion of the body 210.

FIG. 11b illustrates a folding function of the earphone 220, which is moved (i.e., hinged) from a position shown in FIG. 11a.

As shown in the drawings, the earphone 220 can be hinged in the direction shown by the arrow. Thus, it is possible to extend the earphone 220 when the headset 200 is in use and to retract it into the body 210 when the headset 200 is not in use.

The earphone 220 is fixed to the body 210 via a hinge, and thus can move as shown in FIG. 11b. FIG. 11c illustrates the earphone separately, which can be configured into various shapes. FIG. 12 illustrates a fourth embodiment of the invention. FIG. 12 is a side elevation view of a Bluetooth wireless headset 300 having an earphone 320. The earphone 320 is fixed to an outer portion (side) of a body 310 such that it can rotate about a rotation shaft.

As shown, the earphone 320 can be hinged in the direction shown by the arrow. That is, the earphone 320 can be folded. Therefore, the earphone 320 can be extended so that it can be easily inserted into an ear when the headset is to be used. When the headset is not used, the earphone 320 can be rotated onto the upper end of the headset for storage. Accordingly, the earphone 320 can be used very conveniently.

The technical idea disclosed in the third and fourth embodiments of the invention embraces all headsets in which a movable or rotatable earphone is moved or rotated about one shaft.

According to the Bluetooth wireless headset having an earphone of the invention, the earphone is retracted into a body when the headset is not in use, but extended from the body so that the headset can be attached to an ear when the headset is in use, by which a user can use the headset conveniently.

Furthermore, the wireless headset can be easily carried, and the user can more easily use the wireless headset by pushing the earphone with a finger of a hand holding the bar-shaped body.

Moreover, since the earphone of the headset has a folding function, any inconvenience resulting from the earphone fixedly projecting from the body can be avoided.

Although a preferred embodiment of the present invention has been described for illustrative purposes, those skilled in the art will appreciate that various modifications, additions, equivalents and substitutions are possible, without departing from the scope and spirit of the invention as disclosed in the accompanying claims.

What is claimed is:

1. A Bluetooth wireless headset comprising:
an earphone having a speaker;
a telescopic part to which the earphone is attached; and
a body including a built-in Bluetooth chip, wherein the body is bar-shaped and has a space for receiving the telescopic part,
wherein the telescopic part is movable through the space between the body and the earphone.

2. The Bluetooth wireless headset according to claim 1, wherein when the earphone is pressed toward the body while the telescopic part projects from a surface of the body, the telescopic part moves into the space, and wherein, when the earphone is pressed to the body while the telescopic part is stowed in the space, the telescopic part extends from the body.

3. A Bluetooth wireless headset comprising:
an earphone having a speaker;
a telescopic part to which the earphone is attached; and
a body including a built-in Bluetooth chip, wherein the body is bar-shaped and has a space defined by a partition for allowing the telescopic part to move forward to and inward from the earphone;
an earphone-receiving recess depressed into the space from an upper part thereof; and a push switch module having a locking member, arranged at a side of the space to fix the telescopic part of the earphone.

4. The Bluetooth wireless headset according to claim 3, further comprising a coil spring fixed to an interior of the telescopic part and to the bottom of the space to extend the telescopic part via a repulsive force.

5. The Bluetooth wireless headset according to claim 3, wherein when the earphone is pressed to the body while the telescopic part projects from the earphone-receiving recess, the telescopic part moves into the space and couples with the push switch module, thereby maintaining contact with the earphone-receiving recess, and wherein, when the earphone is pressed to the body while the telescopic part is stowed in the space, the telescopic part decouples from the push switch module and separates from the earphone-receiving recess, thereby extending from the body.

6. The Bluetooth wireless headset according to claim 3, wherein the telescopic part includes:
a hollow cylinder;
a guide protrusion projecting horizontally from a bottom end of the cylinder to guide the outward and inward movement of the telescopic part and prevent separation thereof; and
a coupling protrusion projecting horizontally at a position opposite the guide protrusion, wherein the coupling protrusion couples with a locking member of the push switch module to be fixed by the push switch module in the case of inward movement, and decouples from the locking member of the push switch module in the case of outward movement.

7. The Bluetooth wireless headset according to claim 6, wherein the partition has a first guide slit arranged in a corresponding position to guide the outward and inward movement of the guide protrusion of the telescopic part and a second guide slit arranged in a corresponding position to guide the outward and inward movement of the coupling protrusion of the telescopic part so that the coupling protrusion projects out through a side of the partition.

8. The Bluetooth wireless headset according to claim 5, further comprising a third guide slit formed in a side of the push switch module, through which the coupling protrusion can move outward and inward.

9. A Bluetooth wireless headset comprising:
an earphone having a speaker;
a telescopic part to which the earphone is attached; and
a body including a built-in Bluetooth chip, wherein the body is bar-shaped and has a space defined by a cylindrical partition for allowing the telescopic part to move outward to and inward from the earphone;
an earphone-receiving recess depressed into the space from an upper part thereof; and
a locking part arranged in the partition of the body for fixing the telescopic part of the earphone.

10. The Bluetooth wireless headset according to claim 9, further comprising a coil spring fixed to an interior of the telescopic part and to the bottom of the space to extend the telescopic part via a repulsive force.

11. The Bluetooth wireless headset according to claim 9, wherein, when the earphone is pressed to the body while the telescopic part projects from the earphone-receiving recess, the telescopic part moves into the space and is fixed by the locking part, thereby maintaining contact with the earphone-receiving recess, and wherein, when the earphone is pressed to the body while the telescopic part is stowed in the space, the telescopic part is released from the locking part and separates from the earphone-receiving recess, thereby projecting from the body.

12. The Bluetooth wireless headset according to claim 9, wherein the telescopic part includes:
a hollow cylinder;
a guide protrusion projecting horizontally from a bottom end of the cylinder to guide the outward and inward movement of the telescopic part and prevent separation thereof; and
a coupling pin defined by longitudinal cuttings in a region corresponding to the guide protrusion of the cylinder so as to be coupled with or decoupled from the locking part, the coupling pin having an inclined coupling protrusion at an end thereof, the coupling protrusion having a slope at a lower end thereof.

13. The Bluetooth wireless headset according to claim 12, wherein the partition has a guide slit formed in a corresponding position to guide the outward and inward movement of the guide protrusion of the telescopic part.

14. The Bluetooth wireless headset according to claim 12, wherein the locking part includes:
a rectangular slit formed at a side of the partition;
a coupling protrusion extending inward from a longitudinal edge of the rectangular slit and having a downward slope so that the coupling protrusion of the coupling pin engages along the slope of the coupling protrusion of the locking part when the coupling pin moves outward after having moved inward;
a quadrangular guide protrusion formed at a lower end of the coupling protrusion of the locking part to guide and bend the slope of the coupling protrusion of the coupling pin; and
a guide surface formed between the coupling protrusion and the guide protrusion, by which when the coupling protrusion of the telescopic part moves outward from the bent position, the coupling protrusion of the telescopic part does not re-couple with the coupling protrusion of the coupling part due to the guide protrusion.

15. A Bluetooth wireless headset according to claim 9, further comprising:
a movable earphone having a speaker; and
a body including a built-in Bluetooth chip, the body having a space for receiving the earphone,
wherein the earphone is hinge-mounted on the body.

16. A Bluetooth wireless headset according to claim 9, further comprising:
a movable earphone having a speaker; and
a body including a built-in Bluetooth chip, wherein the earphone is mounted on an exterior of the body, the earphone being rotatable about a rotation shaft.
